(19) United States
(12) Patent Application Publication
(10) Pub. No.: US 2009/0235888 A1
(43) Pub. Date: Sep. 24, 2009

(54) Device for Injecting a Liquid Additive Into the Fuel Supply System of an Internal Combustion Engine of a Motor Vehicle

(75) Inventors: Didier Comtat, Monteux (FR); Marc Novellani, Vacqueyras (FR)

Correspondence Address: OLIFF & BERRIDGE, PLC, P.O. BOX 320850, ALEXANDRIA, VA, 22320-4850, US

(73) Assignee: MGI Coutier, Champfromier (FR)

(21) Appl. No.: 11/922,387

(22) PCT Filed: Jul. 6, 2006
(86) PCT No.: PCT/FR2006/001622

§ 371 Date: Feb. 27, 2008

(30) Foreign Application Priority Data
Jul. 11, 2005 (FR) 0507401

(51) Int. Cl. F02M 25/00

(52) U.S. Cl. 123/1 A

(57) ABSTRACT

The device for injecting an additive comprises a removable flexible pouch forming a liquid additive reservoir connected to the fuel supply system of the engine via a quick-connect element to an additive feed line that supplies a dosing pump. The flexible pouch retracts whereby reducing its inside volume in order to compensate for the drop in pressure created inside as the additive is drawn out of the pouch. The flexible pouch is formed by two essentially oblong and rounded layers primarily made of thermoplastic polyurethane (TPU), in particular, ester-based whose perimeters forming lips are welded to one another by a weld bead. The invention is for use in direction injection diesel engines.

The present invention is concerned in general with motor vehicle internal combustion engines equipped with pollution reducing devices (for example particle filters or NOx traps) that have to be supplied with special purpose fuel. It relates in particular to a device for injecting a liquid additive (based on cerium and/or iron salts in the case of particle filters or based on urea in the case of NOx traps) into a standard fuel contained in the supply circuit of such an engine, with a view to altering the composition of the fuel to make it compatible with the pollution-reduction device fitted to the engine.

One particular known application of this device is in the field of direct injection diesel engines. The exhaust line of a motor vehicle diesel engine may contain a particle filter which essentially traps a large proportion of the microparticles of carbon and therefore reduces their emissions into the atmosphere to levels permitted by the current or future emissions standards. This filter needs to be cleaned regularly, generally every 400 to 500 kilometers to prevent it from becoming completely clogged. This cleaning operation is typically performed under the control of the engine management computer via post injections which increase the temperature in the particle filter to burn off the soot when the engine is running.

When the temperature of the exhaust gases is around 550° C., the soot deposited in the particle filter is burnt off. However, under certain conditions, for example in built-up areas, this post combustion is not feasible because the temperature in the exhaust line and the engine speed are too low. As a result, there is a risk that the filter will become clogged and will choke the engine.

To remedy this problem, one known solution is to inject a liquid additive, for example containing cerium salt and/or iron salt, into the diesel fuel, each time the vehicle fuel tank is filled up. The additive has to be injected in a determined quantity in relation to the volume of diesel fuel introduced into the tank in order to obtain an additive/fuel mixture of a determined concentration, for example approximately 8 ml of additive per 50 liters of diesel fuel. This mixture lowers the particle filter regeneration temperature from 550° C. to approximately 450° C., thus allowing the particle filter to be cleaned at exhaust line temperatures lower than the temperature normally required without the additive, thus for example allowing regeneration to take place when the vehicle is driving in urban environments.

One device that is already known for injecting a liquid additive into the diesel fuel contained in the supply circuit of a road-going vehicle diesel engine is described in patent FR 2 805 002 in the name of the applicant. This device comprises a removable flexible pouch forming a liquid additive reservoir, connected to the fuel supply circuit of the engine by an additive supply line which feeds into a metering pump designed to inject the required amount of additive into the circuit, the flexible pouch contracting in such a way as to reduce its interior volume in order to compensate for the drop in pressure generated inside it as the additive is drawn from the pouch.

The flexible pouch is of cylindrical overall shape with a bendy sidewall exhibiting annular radial pleats, so as to form a bellows capable of contracting axially. The flexible pouch thus constitutes a removable additive refill which, once empty, is quickly removed and easily replaced with a new one. The user does not have to worry about filling the additive reservoir, thus avoiding him the trouble of having to handle and come into contact with the harmful and pollutant liquid additive.

When the residual volume of additive inside the pouch is small, most of the initial contents of the flexible pouch having been consumed, it becomes more difficult for the metering pump to pump out the liquid because the limit of axial contraction of the “bellows” has almost been reached. Furthermore, some additive may find itself trapped between the annular pleats of the bendy longitudinal wall of the pouch. That may have an adverse effect on the accuracy with which the additive/fuel mixture can be metered, particularly with the newer, more concentrated additives that have been developed with a view to using and transporting a smaller volume of product.

The present invention is aimed at avoiding these disadvantages by providing a simple and reliable injection device which provides a uniform additive/fuel mixture of determined, constant and precise concentration.

To these ends, a subject of the invention is a device for injecting a liquid additive as defined in the preamble, and in which the flexible pouch is made of two sheets of oblong and rounded overall shape made chiefly of thermoplastic polyurethane (TPU), particularly ester based, the lip-forming peripheries of which are welded together along a welded seam.

Thus, the inventive step is to use a flexible pouch the simple, flat, cornerless shape of which is optimized so as not to generate any region where air or additive can become trapped, and to contract readily until a zero interior volume is reached (with the sheets pressed one upon the other) and allow the metering pump to pump the additive from the pouch without difficulty, even when the residual volumes of fluid are very small.

Thermoplastic polyurethane is a particularly advantageous material because it is compatible with the main additives on the market most of which consist of solvent with a small amount of active ingredient (for example cerium or iron salt, etc.). The low permeability of this material (particularly in the case of ester-based polyurethanes) to the additive solvents minimizes the losses of additive by evaporation, gives an active ingredient concentration that remains stable and precise throughout the service life of the pouch, and therefore guarantees the precision with which the additive/fuel mixture can be metered, particularly with the newer, more concentrated additives.

The glass transition temperature of this material is very low, making it able effectively to tolerate the vibrational stresses on the vehicle, over a temperature range standing between about −30° C. and 90° C.

Finally, the very great flexibility of this material used, for example, in a film 300 μm thick, particularly its elongation at break capability in excess of 300% (even at the temperature of −30° C.) and the breaking stresses in excess of 300 N, allow it to withstand the deformations and foldings brought about under dynamic conditions as the vehicle is running and the pouch is being emptied, in handling and transport, and able to withstand abrasion against the internal walls of a pouch receptacle.

Depending on the nature of the additive and the frequency with which the pouch is renewed, the sheets of the flexible pouch may comprise a barrier layer, for example a layer of ethylene vinyl alcohol copolymer (EVOH) approximately 10 microns thick, coated on each side, particularly by means of a suitable binder, with a layer of thermoplastic polyurethane (TPU).

The sheets of the flexible pouch advantageously have a total thickness of about 300 microns, giving sufficient mechanical strength for the application, a level of permeability suited to the current additives, and at the same time allowing the metering pump to pump with ease. Specifically, too great a thickness would lead, at low temperature, particularly at −30° C., to excessive stiffening which would impede the precision of the metering.

To allow the flexible pouch to be filled or emptied, the welded seam between the lips of the sheets of the pouch delimits, in a region of a long side of the pouch, a neck designed to accept said quick coupling element for coupling to the additive supply line.

When it is being filled, the pouch needs to contain a minimal amount of air in order not to introduce errors into the metering. To achieve this, the neck advantageously widens toward the inside of the pouch, in the manner of a funnel, to encourage degassing of the pouch as it is being filled, and also makes for ease of pumping, even for very small residual volumes of additive.

According to one possibility, a discontinuous line of welding likenable to a dotted line, is run parallel to the welded seam between the sheets of the pouch, on the inside thereof in the solid area of the pouch so as to form a duct continuously channeling additive toward the neck.

According to another possibility, the quick coupling element for coupling the pouch to the additive supply line is connected to a pipe running inside the pouch and pierced with a plurality of holes. The path of the pipe through the pouch and the arrangement of the holes in the pipe are designed to optimize the emptying of the pouch and to vent air when the pouch is being filled.

According to a complementary aspect, a fixed rigid mount is provided to hold the pouch in place and comprises an eye of oblong shape designed to hold the neck and keep it in the flow position, particularly in the case of a pouch that is positioned vertically. This makes it possible to avoid the neck becoming obstructed by crushing as this would prevent the additive from flowing out of the pouch. Other means of holding the neck in the flowing position are conceivable.

Advantageously, this mount also has, on its opposite side to the pouch, a clamp for holding the quick coupling element used to coupled the pouch to the additive supply line.

The quick coupling element for coupling the pouch to the additive supply line is, for example, a self-sealing valve welded directly between the lips of the sheets of the pouch or forcibly inserted into a connecting pipe welded between the lips of the sheets of the pouch in the region of the neck. This valve guarantees that there will be no losses of additive before the pouch is fitted onto the vehicle, during the handling and transport phases and after the pouch has been removed from the vehicle (in order to replace it).

Another subject of the invention is a removable flexible pouch for a liquid additive injection device as described hereinabove.

The present invention and its advantages will become better apparent from the following non-limiting description of a number of exemplary embodiments and with reference to the attached drawings in which:

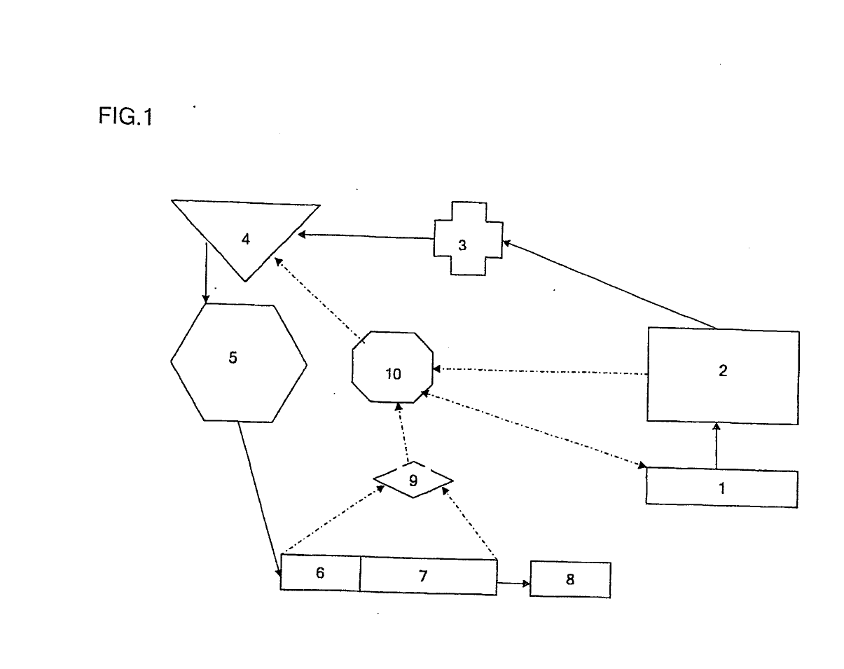

FIG. 1 is a schematic view of the fuel supply circuit of an engine, equipped with a particle filter in its exhaust line, to which the additive injection device according to the invention is coupled;

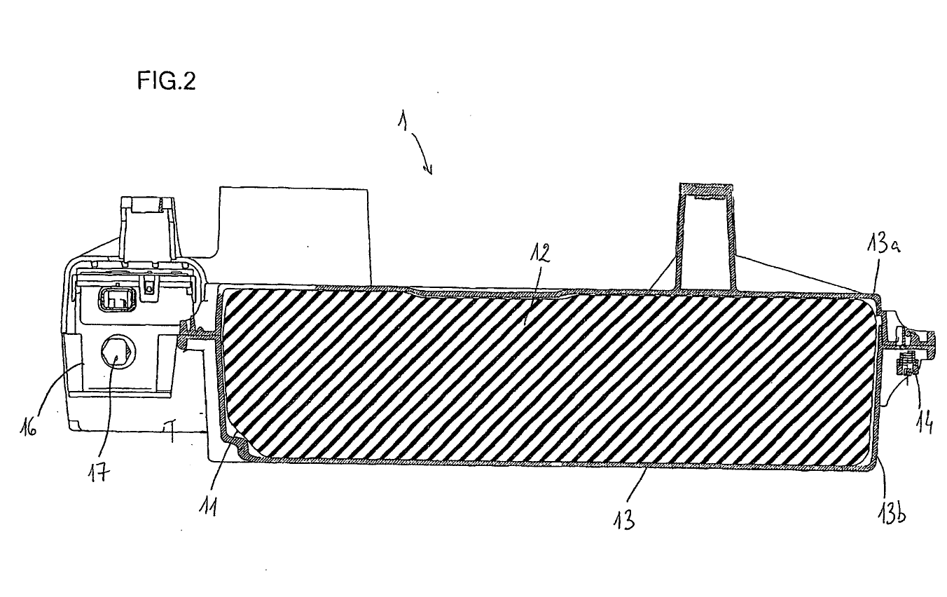

FIG. 2 is an overall view, in cross section, of an injection device according to a first embodiment of the invention, comprising a flexible pouch positioned horizontally;

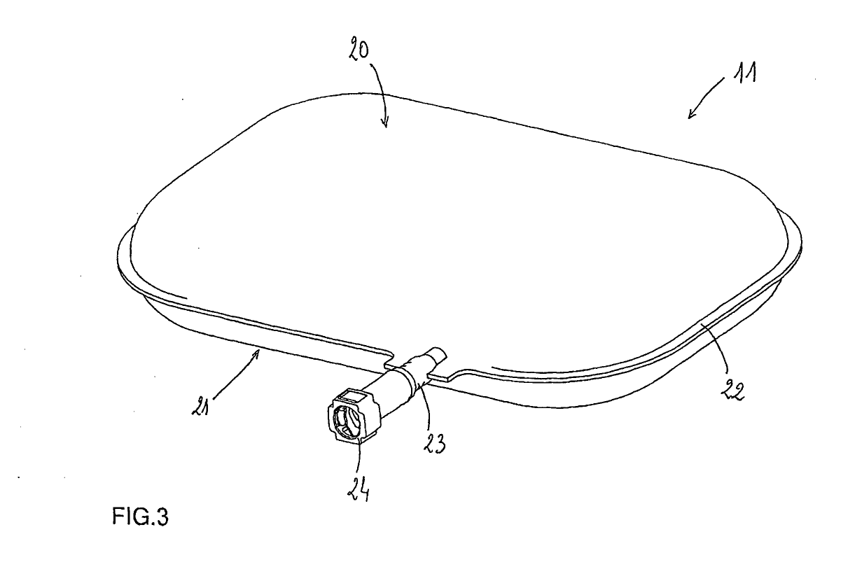

FIG. 3 is a perspective view of a first example of a flexible pouch that can be used in the context of the present invention;

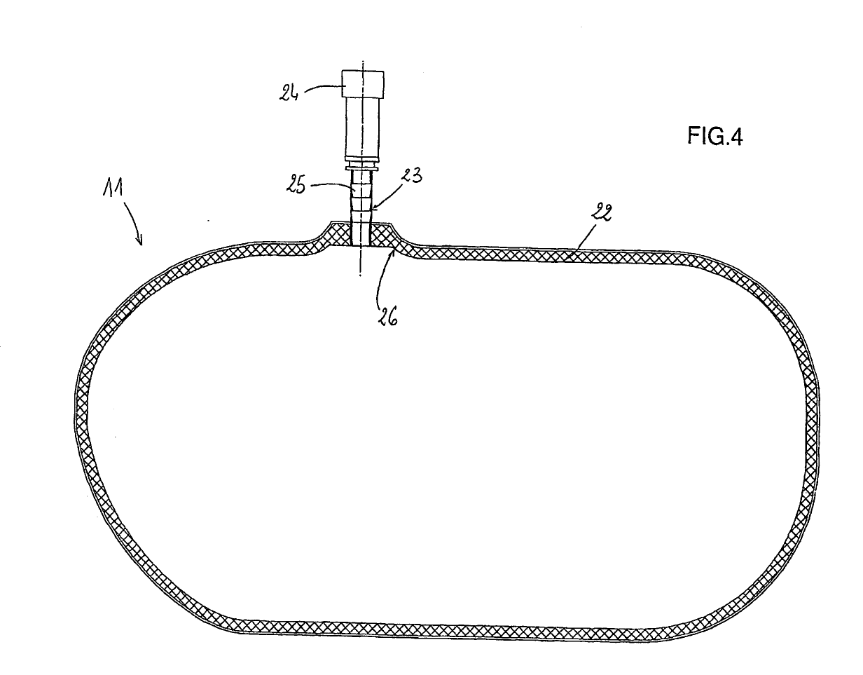

FIG. 4 is a view in cross section of the flexible pouch of FIG. 3;

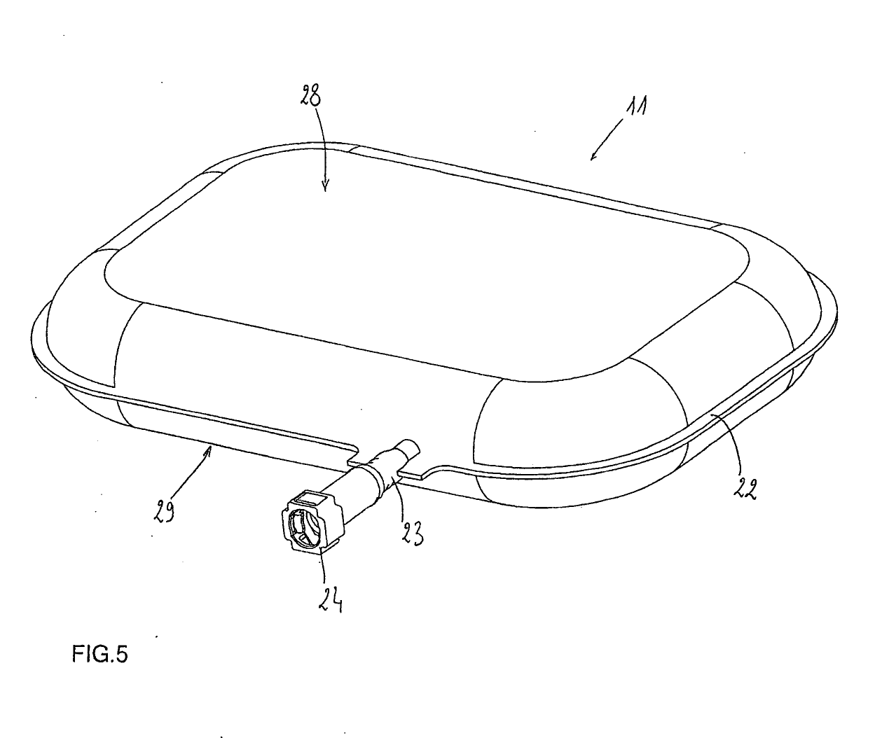

FIG. 5 is a perspective view of a second example of a flexible pouch that can be used in the context of the invention;

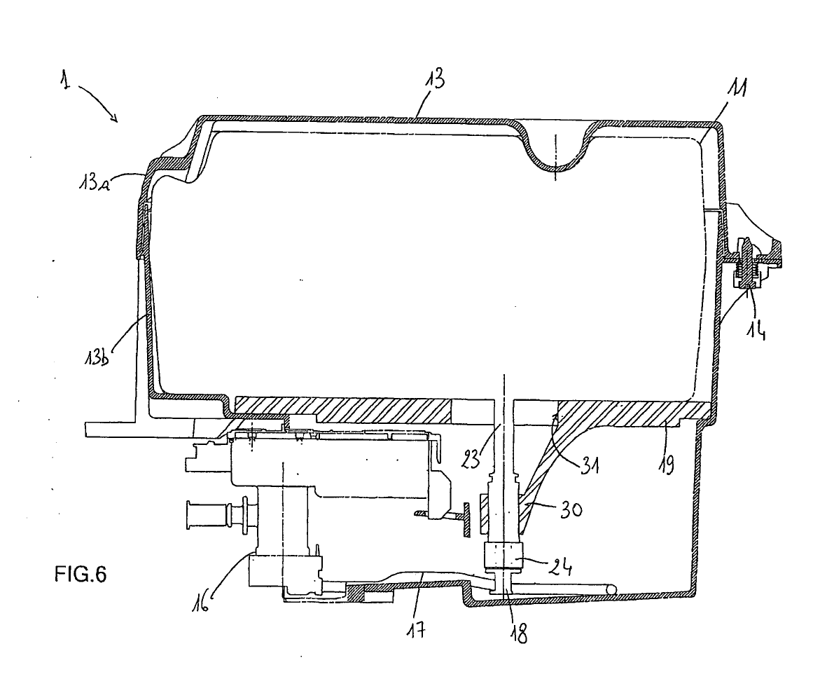

FIG. 6 is an overall view in cross section of an injection device according to a second embodiment of the invention, comprising a flexible pouch positioned vertically;

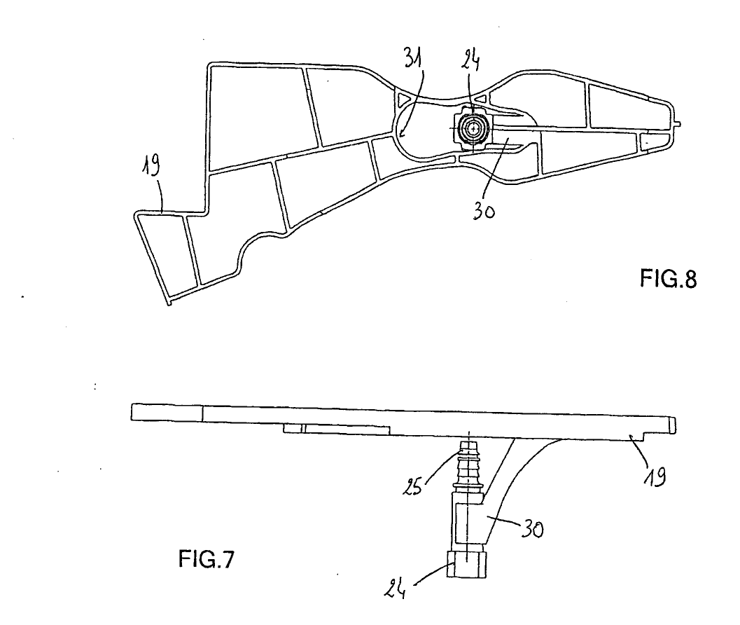

FIG. 7 is a side view of the mount used to retain the pouch in FIG. 6;

FIG. 8 is a view from beneath of the retaining mount of FIG. 7;

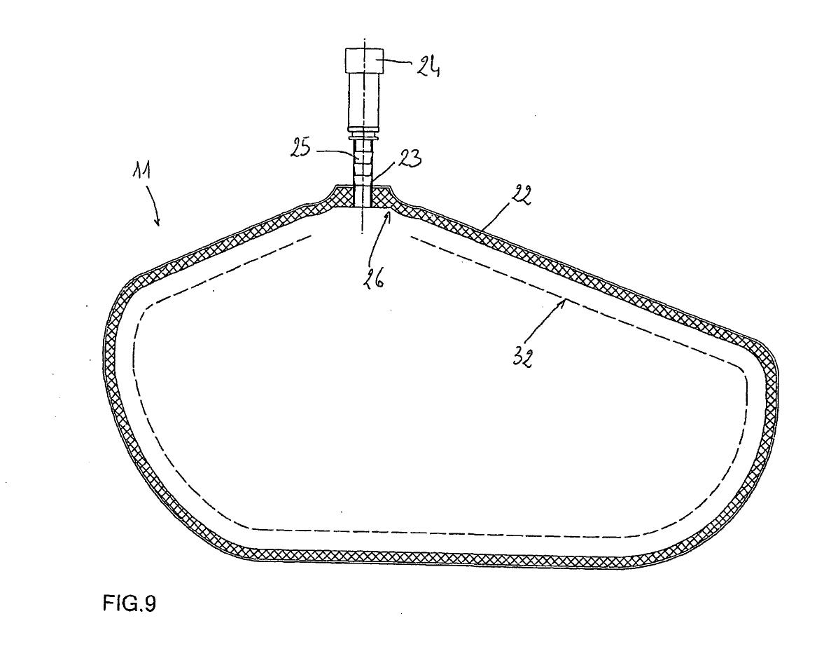

FIG. 9 is a view similar to FIG. 4 depicting a flexible pouch with a flow duct formed by welding on the inside of the pouch;

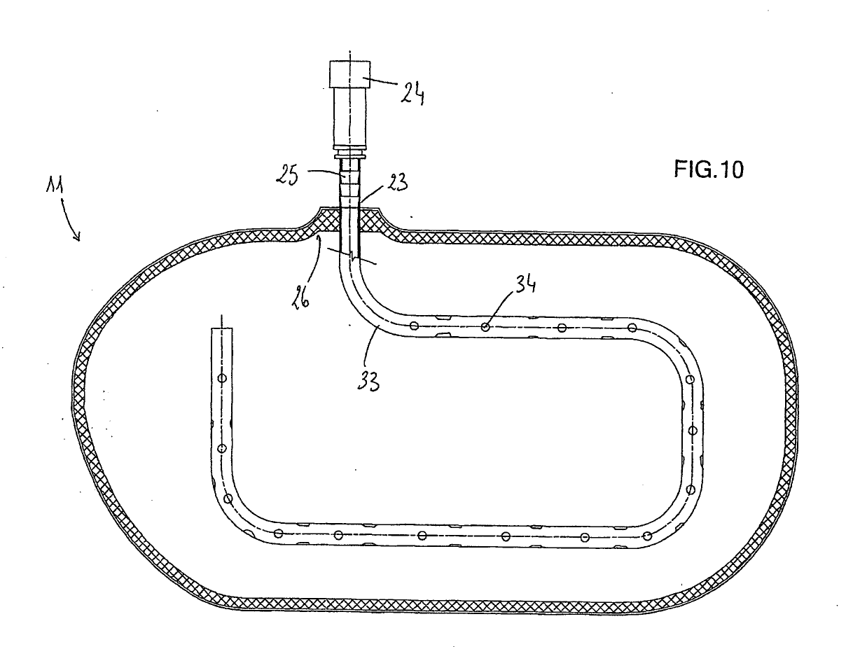

FIG. 10 is a view similar to FIG. 9 with a flow duct produced in the form of a holed pipe running inside the pouch;

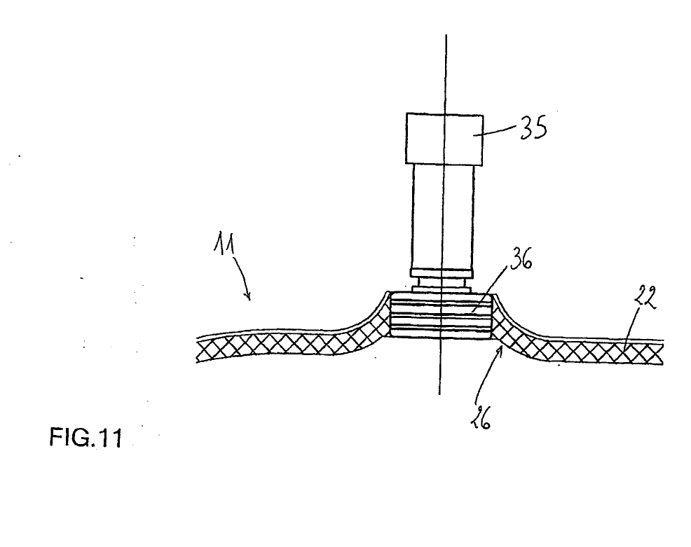

FIG. 11 partially depicts a flexible pouch equipped with a special-purpose self-sealing valve welded directly to its neck;

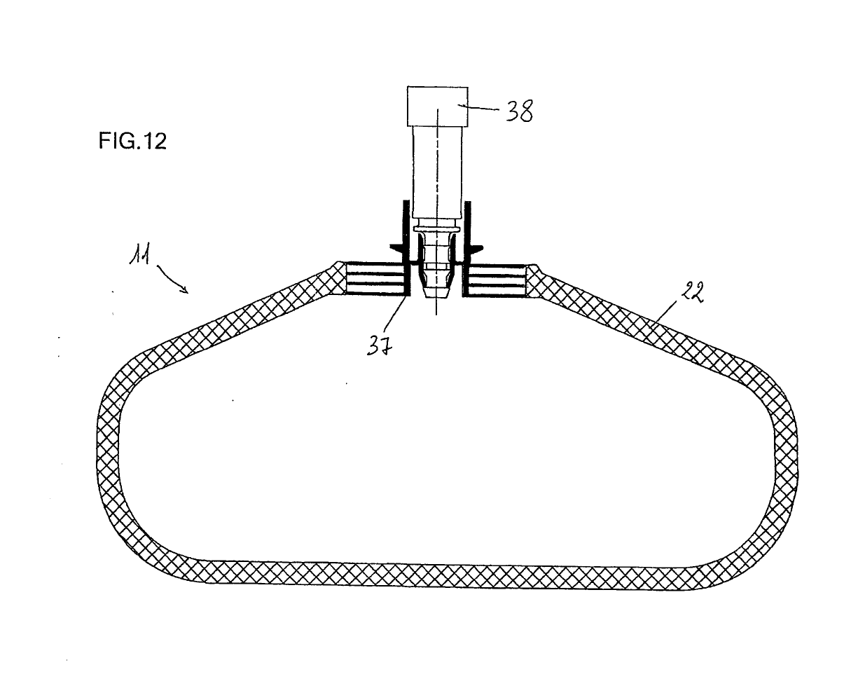

FIG. 12 depicts a flexible pouch equipped with a special-purpose neck to which a self-sealing valve can be attached by clip fastening;

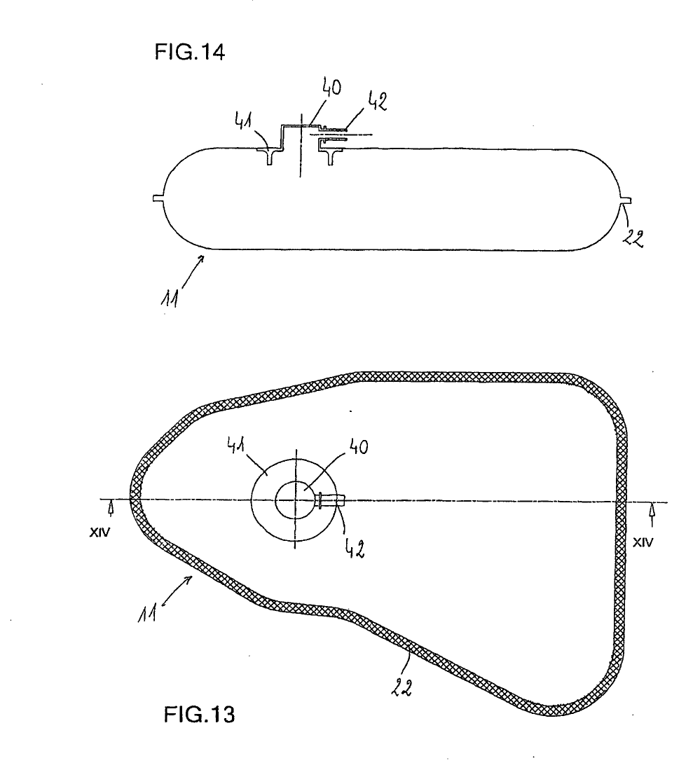

FIG. 13 depicts a flexible pouch equipped with a different type of interface with a self-sealing valve;

FIG. 14 is a view in section on XIV-XIV of FIG. 13.

With reference to FIG. 1, the device for injecting additive according to the invention, denoted overall by the numerical reference 1, is connected to the fuel tank 2 of a motor vehicle. The fluidic circuit is represented by continuous lines while the electrical circuit is represented by dotted lines.

The fuel tank 2 is connected to a high-pressure pump 3 designed to supply a fuel injection system 4 for injecting fuel into the engine 5 of the vehicle with fuel to which additive has been added. The engine 5 discharges the exhaust gases into a pre-catalytic converter 6 and then into a particle filter 7 and finally into an exhaust muffler 8. The pressures in the pre-catalytic converter 6 and in the particle filter 7 are measured using pressure sensors 9.

When the tank 2 is being filled with fuel, a fuel gauge (not depicted) informs a computer 10 of the volume of fuel added to the tank 2. The computer 10 then transmits an instruction to the additive injection device 1 to inject an amount of additive proportional to the amount of fuel introduced into the fuel tank 2.

The additive, which for example contains cerium salt and/or iron salt, covers the particles of soot stemming from combustion and lowers their combustion temperature so as to allow effective regeneration, even at low speed, at limited temperatures (around 450° C.) in the exhaust, whereas regeneration without additive would entail temperatures of the order of 600° C.

In an optimized embodiment, a temperature sensor (not depicted) may be positioned in the additive injection device 1. The temperature sensor informs the computer 10 of the additive temperature. This computer, using calibration curves, will adjust the dosage (for example the metering time) according to the variations in density and viscosity of the additive that accompany the variations in temperature.

In the embodiment depicted in FIG. 2, the additive injection device 1 comprises a flexible pouch 11, with a capacity of 1.5 to 5 liters, forming a liquid additive reservoir 12 and contained horizontally in a casing 13 consisting of two injection-molded half-shells 13a and 13b joined together, in this instance by fixing screws 14. The pouch 11 constitutes an additive refill positioned fully in the casing 13. The casing 13 protects the pouch 11 and is fixed to the body of the vehicle by fixing lugs, dovetails or the like.

The device 1 also comprises an electric metering pump 16 supplying the fuel tank 2 with additive via an outlet pipette 15. The metering pump 16 is, for example, a peristaltic pump, a piston pump or a diaphragm pump. A drive motor (not depicted) that drives the metering pump 16 is controlled by the computer 10 to pump a required amount of liquid additive from the pouch 11 according to the volume (measured by the gauge) of fuel introduced into the reservoir 2, so as to obtain a defined and constant concentration of additive/fuel mixture in the tank 2.

As the flexible pouch 11 empties, it contracts to compensate for the drop in pressure generated inside by the pumping out of additive. Once empty, the pouch 11 is quickly and easily removed and replaced with a new one. The empty pouch can possibly be recycled at the factory.

As indicated by FIG. 3, the pouch 11 is made by assembling two flat (prior to filling) sheets 20 and 21, of oblong and rounded overall shape joined at their peripheral lips by a welded seam 22. The sheets 20 and 21 respectively form the top and bottom walls of the flexible pouch 11.

The sheets 20 and 21 are made of a film of thermoplastic polyurethane, particularly one based on ester, in order to minimize losses of additive through permeability. Depending on the nature of the solvent, its concentration in active ingredient and the maximum level of permeability tolerated in the mission profile considered, a barrier layer of ethylene vinyl alcohol copolymer (EVOH) about 10 microns thick may be incorporated into the film.

In a favored embodiment, the barrier layer is “sandwiched” between two layers each approximately 150 μm thick, the adhesion between the EVOH and the polyurethane film being either natural or promoted by a binder according to the grades chosen.

The sheets 20 and 21 are each about 300 microns thick. This thickness offers sufficient mechanical strength for the application, a level of permeability that suits the current additives while at the same time allowing for either pumping via the metering pump 16, particularly at a temperature of −30° C. at which excessive thickness would lead to excessive stiffening which would impede the precision of the metering.

The welded seam 22 has to be robust enough to cope with all the mechanical stresses: the seam is therefore sufficiently wide at about 10 mm, and is preferably a high frequency weld, HF welding being particularly well suited to thermoplastic polyurethane sheets of a thickness such as this. Furthermore, the welding will advantageously be of the electrode/counter electrode type, guaranteeing the uniformity of the seam. The thickness of the seam is optimal in a range representing between 100 and 130% of the thickness of the sheet.

The welded seam 22 delimits, in a region of a long side of the pouch 11, a neck 26 with “slopes” that widens toward the inside of the pouch 11, in the manner of a funnel. When it is being filled, the pouch 11 needs to contain a minimal amount of air in order not to introduce error into the metering of the additive/diesel fuel mixture.

The slopes of the neck 26 encourage air bubbles to rise up toward the neck 26 and thus avoid the formation of regions where air might become trapped. The shape of the neck 26 thus encourages the degassing of the pouch 11 when it is being filled, and also allows additive to be pumped easily from the pouch 11, even when the residual volumes of additive are very small (lower than one deciliter), preventing the formation, during the emptying of the pouch, of pleats which might obstruct the neck 26.

The neck 26 of the pouch 11 is extended outward by a tube 23 comprising an external layer of polyurethane via which the tube 23 is welded directly between the two sheets 20 and 21 at the same time as the sheets 20 and 21 are welded together to produce the pouch 11. Production of the pouch 11 thus entails just a single welding operation, thus optimizing production rates and costs.

The tube 23 comes flush with the internal wall of the pouch 11 in order not to risk abrading this wall, and in order not to trap air during filling or fluid during emptying of the pouch in service.

A self-sealing valve 24 has an end piece 25 of the ordinary type, here “Christmas tree” serrations, via which the valve 24 is forcibly inserted into the tube 23 (see FIG. 4). The valve 24 guarantees that there will be no losses of additive before the pouch 11 is mounted on the vehicle, during the phases of handling and transport, or after the pouch 11 has been removed from the vehicle in order to replace it.

This configuration allows the use of a self-sealing valve 24 of a standard type, hence reducing costs. The self-sealing valve 24 can be fitted before or after the pouch 11 and the tube 23 are welded. An end piece 18 clip-fastened into the valve 24 releases additive into a flexible pipe 17 which supplies the metering pump 16 (see FIG. 6).

The additive temperature sensor mentioned earlier and belonging to the additive injection device 1 is, for example, incorporated into the self-sealing valve 24 of the flexible pouch 11.

As illustrated in FIG. 5, the flexible pouch 11 can thus be produced by welding together two sheets 28 and 29 which have been preformed by a thermoforming operation.

Thermoforming may serve to initiate cavities in the flexible pouch 11 so as to control the distribution of additive in the thickness direction of the pouch 11. This thermoforming may also serve to generate one or more pleats which will be able to act like bellows in order to control the deformation of the pouch 11 as the additive is pumped out.

In the embodiment depicted in FIG. 6, the pouch 11 is positioned vertically, preferably with the neck 26 directed downward to make pumping out easier. The pouch 11 is still held in place by a casing 13 made in two parts 13a and 13b screwed or clip-fastened together with or without hinges.

A supporting mount 19 is inserted into the casing 13 under the pouch 11 to form a flat and smooth bearing surface to avoid abrading the pouch 11, particularly under vibration. The opposite face of the mount 19 to the pouch 11 (see FIG. 8) is ribbed in such a way as to reduce the amount of material and to strengthen the component.

The mount 19 has on its underside a clamp 30 for holding the valve 24 in position (see FIG. 7) so as to prevent the welded tube 23 or the valve 24 from coming back up toward the pouch 11 as this could damage the pouch 11 from the inside, and also to prevent, under vibration, any relative movement between the valve 24 and the pouch 11 as this may be liable to exert stress on the pouch 11, particularly at the welded seams.

The length of the clamp 30 is tailored for optimum positioning that generates the least possible amount of stress in the weld region of the tube 23.

To make it easier to pump out the additive, the mount 19 in its central region has an oblong-shaped eye 31 which holds the neck of the pouch 11 and keeps it in the flow position, that is to say in such a way as to prevent the neck from becoming obstructed by any crushing which would prevent the additive from flowing out of the pouch 11 (see FIGS. 6 and 8).

In FIG. 9, a line of welding 32 which is discontinuous in the manner of dotted lines is applied parallel to the welded seam 22 between the walls 20, 21 of the pouch 11, on the inside, in the solid surface of the pouch 11, so as to form a duct continuously channeling additive toward the neck 26 around the entire periphery of the pouch 11 and prevent pleats or other deformations from forming which might create regions in which additive would become trapped as the vehicle runs along or as the pouch 11 is emptied.

In FIG. 10, the tube welded at the neck 26 of the pouch 11 and which provides the connection with the self-sealing valve 24, is produced in the form of a pipe 33 pierced with a multitude of holes 34 and running along inside the pouch 11 in such a way as to form a duct that continuously channels additive toward the neck 26.

The pipe 33 is thermoformed to encourage the pouch 11 to deform into a flat shape as it empties. The holes 34 provided in the pipe 33 allow additive to be pumped out throughout the use of the pouch 11 as it empties and in particular prevent the throughput from being limited by the formation of pleats.

The path of the pipe 33 through the pouch 11 and the arrangement of the holes 34 are designed to optimize the emptying of the pouch 11 and to vent the air while the pouch 11 is being filled.

Other alternative forms of embodiment illustrated in the following figures are also conceivable and make it possible to dispense with the tube, welded to the pouch, for connection to the self-sealing valve.

FIG. 11 depicts a self-sealing valve 35 welded directly onto the pouch 11 via, for example, a thermal weld. The welded part 36 of the valve 35 is compatible with the polyurethane of the pouch 11 and has a profile with welding striations in the continuation of the welded seam 32.

FIG. 12 shows the pouch 11 equipped with a special-purpose neck 37 sandwiched and welded between the sheets 20, 21 of the pouch 11, and into which a self-sealing valve 28 of appropriate shape can be clip-fastened.

The embodiment illustrated in FIGS. 13 and 14 makes it possible to overcome certain geometric constraints. The pouch 11 is equipped with an output interface 40 welded directly onto the skin of the pouch 11, some way away from the welded seam 22. The welded part 41 of the interface 40 is compatible with the external surface of the pouch 11. The interface 40 comprises a simple end piece of the clip-in male type 42 or has serrations in the form of a Christmas tree (which may be a rotation proofing profile). It may also incorporate a self-sealing valve or any other anti-blockage device to prevent blockages while the pouch 11 is being emptied.

As goes without saying, the present invention is not restricted to the embodiments described hereinabove or to the particular application thereof cited by way of example, but encompasses any modification or variant that is obvious to those skilled in the art. In particular, the following would not constitute departure from the scope of the invention:
if the shapes, dimensions, and numbers of parts of which the invention is formed, and the arrangement thereof, were modified,
if other means were to be used for keeping the neck in the flow position.

1. A device for injecting liquid additive into the fuel supply circuit of a motor vehicle internal combustion engine, comprising a removable flexible pouch forming a liquid additive reservoir, connected to the fuel supply circuit of the engine by a quick coupling element for coupling to an additive supply line which feeds into a metering pump, the flexible pouch contracting in such a way as to reduce its interior volume in order to compensate for the drop in pressure generated inside it as the additive is drawn from the pouch, wherein the flexible pouch is made of two sheets of oblong and rounded overall shape made chiefly of thermoplastic polyurethane (TPU), particularly ester based, the lip-forming peripheries of which are welded together along a welded seam.

2. The device for injecting liquid additive as claimed in claim 1, wherein the sheets of the flexible pouch comprise a barrier layer, the barrier layer being a layer of ethylene vinyl alcohol copolymer (EVOH) approximately 10 microns thick, coated on each side, particularly by means of a suitable binder, with a layer of thermoplastic polyurethane (TPU).

3. The device for injecting liquid additive as claimed in claim 1, wherein the sheets of the flexible pouch have a total overall thickness of about 200 microns.

4. The device for injecting liquid additive as claimed in claims 1, wherein the welded seam between the lips of the sheets of the pouch delimits, in a region of a long side of the pouch, a neck designed to accept said quick coupling element for coupling to the additive supply line.

5. The device for injecting liquid additive as claimed in claim 4, wherein-the neck widens toward the inside of the pouch.

6. The device for injecting liquid additive as claimed in claim 1, wherein a discontinuous line of welding likenable to a dotted line, is run parallel to the welded seam between the sheets of the pouch, on the inside thereof in the solid area of the pouch so as to form a duct continuously channeling additive toward the neck.

7. The device for injecting liquid additive as claimed in claim 1, wherein the quick coupling element for coupling the pouch to the additive supply line is connected to a pipe running inside the pouch and pierced with a plurality of holes.

8. The device for injecting liquid additive as claimed in claim 1, wherein a fixed rigid mount is provided to hold the pouch in place and comprises an eye of oblong shape designed to hold the neck and keep it in the flow position, particularly in the case of a pouch that is positioned vertically.

9. The device for injecting liquid additive as claimed in claim 8, wherein the mount has, on its opposite side to the pouch, a clamp for holding the quick coupling element used to coupled the pouch to the additive supply line.

10. The device for injecting liquid additive as claimed in claim 1, wherein the quick coupling element for coupling the pouch to the additive supply line is a self-sealing valve welded directly between the lips of the sheets of the pouch or forcibly inserted into a connecting pipe welded between the lips of the sheets of the pouch in the region of the neck.

11. A removable flexible pouch for a liquid additive injection device as claimed in claim 1.
